(19) United States
(12) Patent Application Publication
(10) Pub. No.: US 2016/0309520 A1
(43) Pub. Date: Oct. 20, 2016

(54) BASE STATION AND METHOD

(71) Applicant: KYOCERA CORPORATION, Kyoto (JP)

(72) Inventor: Keiji MURAKAMI, Kawasaki-shi (JP)

(73) Assignee: KYOCERA CORPORATION, Kyoto (JP)

(21) Appl. No.: 15/191,629

(22) Filed: Jun. 24, 2016

Related U.S. Application Data
(63) Continuation of application No. PCT/JP2014/083693, filed on Dec. 19, 2014.

(30) Foreign Application Priority Data
Dec. 24, 2013 (JP) 2013-266175

(51) Int. Cl. H04W 74/08

(52) U.S. Cl. CPC H04W 74/0841; H04W 88/08

(57) ABSTRACT

A base station, when receiving a random access preamble transmitted from a plurality of user terminals in a contention based random access procedure, transmits a random access response to the plurality of user terminals. The base station comprises a controller configured to select, when receiving a plurality of connection request messages transmitted by the plurality of user terminals in response to the random access response, a connection request message that satisfies a predetermined condition from among the plurality of connection request messages and to transmit a contention resolution message corresponding to the selected connection request message.

### TECHNICAL FIELD

The present invention relates to a base station used in a mobile communication system and a method therefor.

### BACKGROUND ART

In LTE (Long Term Evolution), specifications of which have been designed in 3GPP (3rd Generation Partnership Project) which is a project aiming to standardize a mobile communication system, as a procedure to establish a connection by a user terminal with a base station, a random access procedure is defined. The random access procedure includes contention based and non-contention based random access procedures.

The contention based random access procedure is utilized when the non-contention based random access procedure is not available, and includes the following four steps.

As a first step, a user terminal selects any preamble sequence from a preamble sequence group available for a contention based random access attempt, and transmits a random access preamble to a base station by the selected preamble sequence. The random access preamble does not include an identifier (terminal identifier) of the user terminal.

As a second step, the base station that receives the random access preamble transmits a random access response to the user terminal. The random access response includes a preamble identifier (preamble index) indicating the preamble sequence of the random access preamble received by the base station.

As a third step, the user terminal that receives the random access response including the preamble identifier corresponding to the random access preamble, transmits a connection request message to the base station. The connection request message includes a terminal identifier.

As a fourth step, the base station that receives the connection request message transmits a contention resolution message to the user terminal. The contention resolution message includes a terminal identifier included in the connection request message received by the base station.

Incidentally, in the contention based random access procedure, a plurality of user terminals may transmit the random access preamble by the same preamble sequence. Such a situation is called a preamble contention (or a preamble collision).

In this case, the plurality of user terminals involving in the preamble contention respond to one random access response transmitted from the base station, and transmit a plurality of connection request messages to the base station. The base station includes the terminal identifier included in the connection request message received first, for example, into the contention resolution message. As a result, out of the plurality of user terminals involving in the preamble contention, a user terminal that first transmits the connection request message establishes a connection with the base station.

On the other hand, a user terminal not designated by the contention resolution message needs to re-start the random access procedure from the first step, and the preamble contention may occur even in the second random access procedure.

Therefore, the contention based random access procedure may take a longer time (connection process delay) required until the user terminal establishes the connection with the base station. In particular, when an emergency call is originated, if the connection process delay is longer, this is a serious problem.

### CITATION LIST

### Non Patent Literature

[NPL 1] 3GPP Technical Specification “TS 36.300 V11.7.0” September, 2013

### SUMMARY OF INVENTION

A first aspect abstracted as a base station that, when receiving a random access preamble transmitted from a plurality of user terminals in a contention based random access procedure, transmits a random access response to the plurality of user terminals, comprising a controller configured to select, when receiving a plurality of connection request messages transmitted by the plurality of user terminals in response to the random access response, a connection request message that satisfies a predetermined condition from among the plurality of connection request messages and to transmit a contention resolution message corresponding to the selected connection request message.

A second aspect is abstracted as a processor installed in a base station that transmits, when receiving a random access preamble transmitted from a plurality of user terminals in a contention based random access procedure, a random access response to the plurality of user terminals, the processor selects, when receiving a plurality of connection request messages transmitted by the plurality of user terminals in response to the random access response, a connection request message that satisfies a predetermined condition from among the plurality of connection request messages and transmits a contention resolution message corresponding to the selected connection request message.

A third aspect is abstracted as a method in a base station that, when receiving a random access preamble transmitted from a plurality of user terminals in a contention based random access procedure, transmits a random access response to the plurality of user terminals, comprising the steps of: selecting, when receiving a plurality of connection request messages transmitted by the plurality of user terminals in response to the random access response, a connection request message that satisfies a predetermined condition from among the plurality of connection request messages; and transmitting a contention resolution message corresponding to the selected connection request message.

### BRIEF DESCRIPTION OF DRAWINGS

FIG. 1 is a configuration diagram of an LTE system according to an embodiment.

FIG. 2 is a block diagram of a UE according to the embodiment.

FIG. 3 is a block diagram of an eNB according to the embodiment.

FIG. 4 is a protocol stack diagram of a radio interface in the LTE system.

FIG. 5 is a configuration diagram of a radio frame used in the LTE system.

FIG. 6 is a sequence diagram showing a contention based random access procedure.

FIG. 7 is a diagram for describing an operation environment according to the embodiment.

FIG. 8 is a sequence diagram showing an operation sequence according to the embodiment.

FIG. 9 is a flowchart showing a detail of a Collision ID storing process according to step S16 of FIG. 8.

FIG. 10 is a flowchart showing a detail of a connection guarantee according to step S50 of FIG. 8.

### DESCRIPTION OF EMBODIMENTS

### Overview of Embodiments

A base station according to one embodiment, when receiving a random access preamble transmitted from a plurality of user terminals in a contention based random access procedure, transmits a random access response to the plurality of user terminals. The base station comprise a controller configured to select, when receiving a plurality of connection request messages transmitted by the plurality of user terminals in response to the random access response, a connection request message that satisfies a predetermined condition from among the plurality of connection request messages and to transmit a contention resolution message corresponding to the selected connection request message.

### Embodiment

A LTE system will be used below as an example to describe embodiments.

(System Configuration)

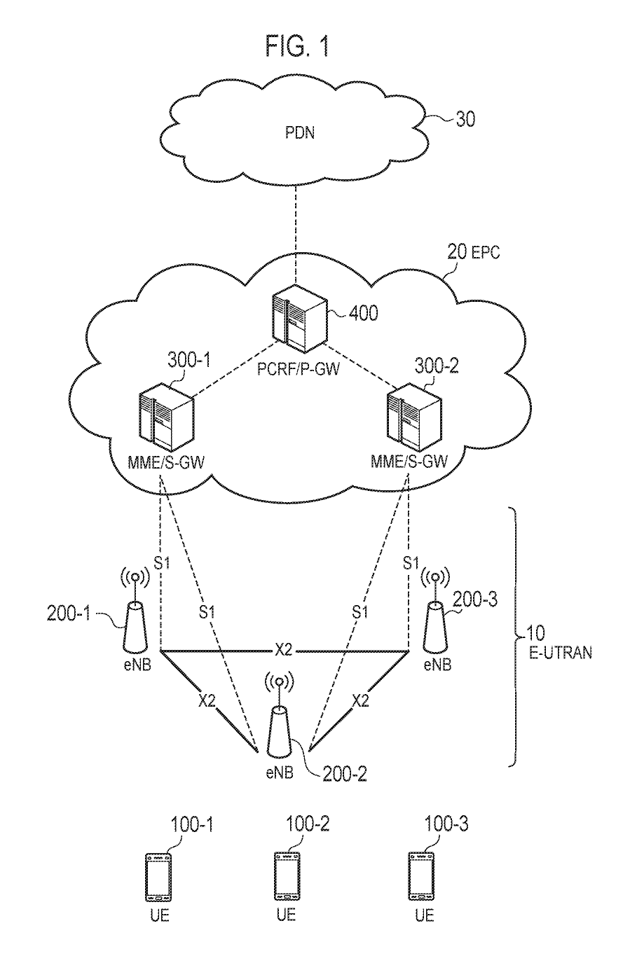

FIG. 1 is a configuration diagram of an LTE system according to an embodiment. LTE system according to an embodiment supports voice communication (VoLTE: Voice over LTE) in a packet exchanging manner.

As illustrated in FIG. 1, the LTE system includes a plurality of UEs (User Equipments) 100, E-UTRAN (Evolved-UMTS Terrestrial Radio Access Network) 10, EPC (Evolved Packet Core) 20 and a PDN (Packet Data Network) 30.

The UE 100 corresponds to a user terminal. The UE 100 is a mobile communication device and performs radio communication with a cell (a serving cell) with which a connection is established. Configuration of the UE 100 will be described later.

The E-UTRAN 10 corresponds to a radio access network. The E-UTRAN 10 includes a plurality of eNBs (evolved Node-Bs) 200. The eNB 200 corresponds to a base station. The eNBs200 are connected mutually via an X2 interface. Configuration of the eNB200 will be described later.

The eNB 200 manages one or a plurality of cells and performs radio communication with the UE 100 which establishes a connection with the cell of the eNB 200. The eNB 200 has a radio resource management (RRM) function, a routing function for user data, and a measurement control function for mobility control and scheduling, and the like. It is noted that the “cell” is used as a term indicating a minimum unit of a radio communication area, and is also used as a term indicating a function of performing radio communication with the UE 100.

The EPC 20 corresponds to a core network. The EPC 20 includes a plurality of MME (Mobility Management Entity)/S-GWs (Serving-Gateways) 300. The MME performs various mobility controls and the like for the UE 100. The S-GW performs control to transfer user data. MME/S-GW 300 is connected to eNB 200 via an S1 interface. Furthermore, the EPC 20 includes a PCRF (Policy and Charging Rules Function)/P-GW (PDN Gateway) 400. The PCRF performs QoS control and accounting control and the like. P-GW is a connection point between the PDN 30, performs control to transfer user data.

The PDN 30 corresponds to an IMS (IP Multimedia Subsystem) for an IP multimedia service. The PDN 30 provides a voice communication service utilizing SIP, etc.

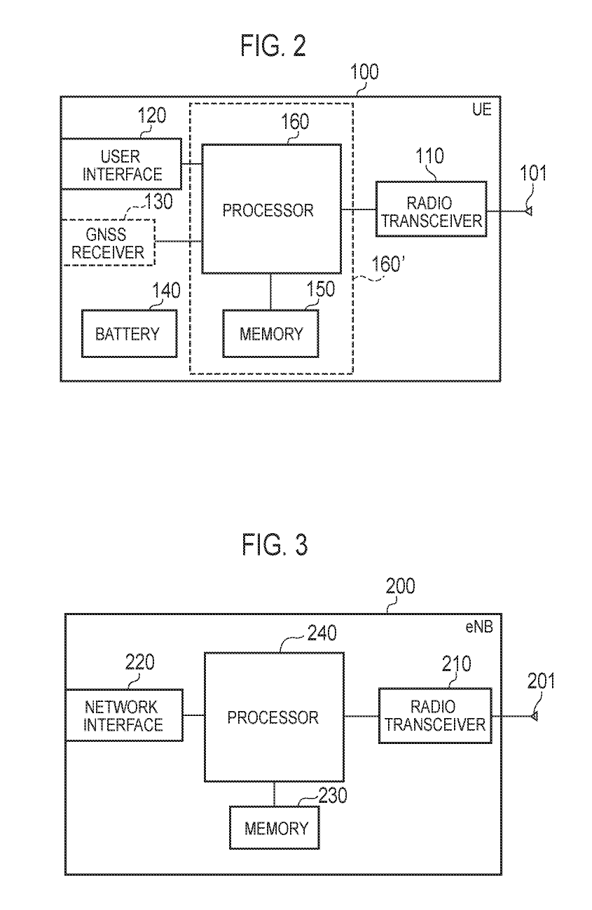

FIG. 2 is a block diagram of the UE 100. As illustrated in FIG. 2, the UE 100 includes antennas 101, a radio transceiver 110, a user interface 120, a GNSS (Global Navigation Satellite System) receiver 130, a battery 140, a memory 150, and a processor 160. The memory 150 and the processor 160 constitute a controller. The UE 100 may not have the GNSS receiver 130. Furthermore, the memory 150 may be integrally formed with the processor 160, and this set (that is, a chip set) may be called a processor 160′.

The antennas 101 and the radio transceiver 110 are used to transmit and receive a radio signal. The radio transceiver 110 converts a baseband signal (a transmission signal) output from the processor 160 into the radio signal and transmits the radio signal from the antenna 101. Furthermore, the radio transceiver 110 converts a radio signal received by the antenna 101 into a baseband signal (a received signal), and outputs the baseband signal to the processor 160.

The user interface 120 is an interface with a user carrying the UE 100, and includes, for example, a display, a microphone, a speaker, various buttons and the like. The user interface 120 accepts an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and CPU (Central Processing Unit) that performs various processes by executing the program stored in the memory 150. The processor 160 may further include a codec that performs encoding and decoding on sound and video signals. The processor 160 executes various processes and various communication protocols described later.

FIG. 3 is a block diagram of the eNB 200. As illustrated in FIG. 3, the eNB 200 includes antennas 201, a radio transceiver 210, a network interface 220, a memory 230, and a processor 240.

The antennas 201 and the radio transceiver 210 are used to transmit and receive a radio signal. The radio transceiver 210 converts a baseband signal (a transmission signal) output from the processor 240 into the radio signal and transmits the radio signal from the antenna 201. Furthermore, the radio transceiver 210 converts a radio signal received by the antenna 201 into a baseband signal (a received signal), and outputs the baseband signal to the processor 240.

The network interface 220 is connected to the neighboring eNB 200 via the X2 interface and is connected to the MME/S-GW 300 via the S1 interface. The network interface 220 is used in communication over the X2 interface and communication over the S1 interface.

The memory 230 stores a program to be executed by the processor 240 and information to be used for a process by the processor 240. The processor 240 includes a baseband processor that performs modulation and demodulation, encoding and decoding and the like on the baseband signal and CPU that performs various processes by executing the program stored in the memory 230. The processor 240 executes various processes and various communication protocols described later.

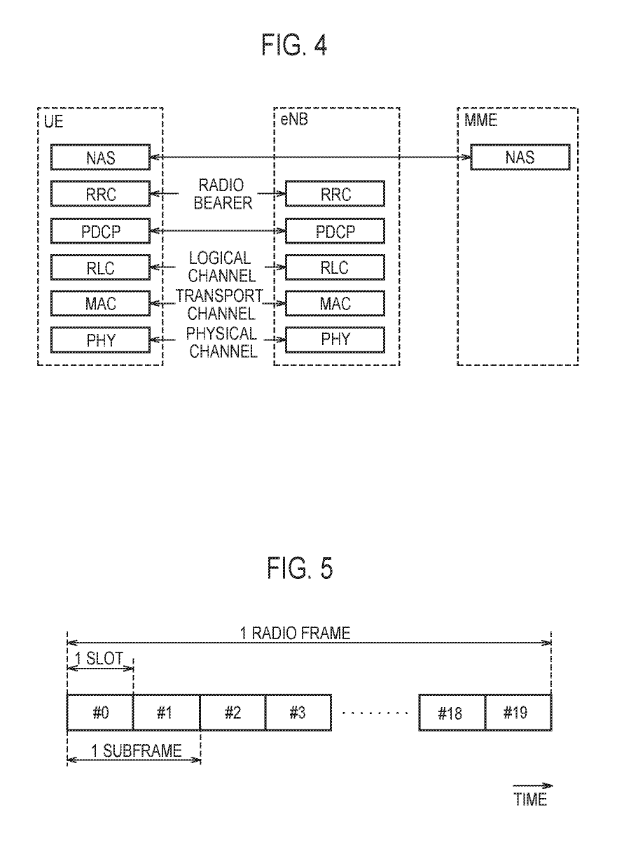

FIG. 4 is a protocol stack diagram of a radio interface in the LTE system. As illustrated in FIG. 4, the radio interface protocol is classified into a layer 1 to a layer 3 of an OSI reference model, wherein the layer 1 is a physical (PHY) layer. The layer 2 includes a MAC (Media Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, use data and control signal are transmitted via the physical channel.

The MAC layer performs priority control of data, a retransmission process by hybrid ARQ (HARQ), a random access procedure at the time of RRC connection establishment, and the like. Between the MAC layer of the UE 100 and the MAC layer of the eNB 200, user data and control signal are transmitted via a transport channel. The MAC layer of the eNB 200 includes a scheduler that determines a transport format of an uplink and a downlink (a transport block size and a modulation and coding scheme (MCS)) and a resource block to be assigned to the UE 100. The detail of the random access procedure will be described later.

The RLC layer transmits data to an RLC layer of a reception side by using the functions of the MAC layer and the PHY layer. Between the RLC layer of the UE 100 and the RLC layer of the eNB 200, user data and control signal are transmitted via a logical channel.

The PDCP layer performs header compression and decompression, and encryption and decryption.

The RRC layer is defined only in a control plane dealing with control signal. Between the RRC layer of the UE 100 and the RRC layer of the eNB 200, control message (RRC messages) for various types of configuration are transmitted. The RRC layer controls the logical channel, the transport channel, and the physical channel in response to establishment, re-establishment, and release of a radio bearer. When there is a connection (RRC connection) between the RRC of the UE 100 and the RRC of the eNB 200, the UE 100 is in a connected state, otherwise the UE 100 is in an RRC idle state.

A NAS (Non-Access Stratum) layer positioned above the RRC layer performs a session management, a mobility management and the like.

FIG. 5 is a configuration diagram of a radio frame used in the LTE system. In the LTE system, OFDMA (Orthogonal Frequency Division Multiplexing Access) is applied to a downlink, and SC-FDMA (Single Carrier Frequency Division Multiple Access) is applied to an uplink, respectively.

As illustrated in FIG. 5, the radio frame is configured by 10 subframes arranged in a time direction, wherein each subframe is configured by two slots arranged in the time direction. Each subframe has a length of 1 ms and each slot has a length of 0.5 ms. Each subframe includes a plurality of resource blocks (RBs) in a frequency direction, and a plurality of symbols in the time direction. The resource block includes a plurality of subcarriers in the frequency direction. Among radio resources assigned to the UE 100, a frequency resource can be specified by a resource block and a time resource can be specified by a subframe (or slot).

In the downlink, an interval of several symbols at the head of each subframe is a control region used as a physical downlink control channel (PDCCH) for mainly transmitting a control signal. Furthermore, the other interval of each subframe is a region available as a physical downlink shared channel (PDSCH) for mainly transmitting user data.

In the uplink, both ends in the frequency direction of each subframe are control regions used as a physical uplink control channel (PUCCH) for mainly transmitting a control signal. Furthermore, 6 resource blocks in the central portion in the frequency direction of each subframe are a region available as a physical random access channel (PRACH). The other interval of each subframe is a region available as a physical uplink shared channel (PUSCH) for mainly transmitting user data.

(Contention Based Random Access Procedure)

The contention based random access procedure will be described, below. The UE 100 performs, prior to establishing the RRC connection with the eNB 200, the random access to the eNB 200 in the MAC layer.

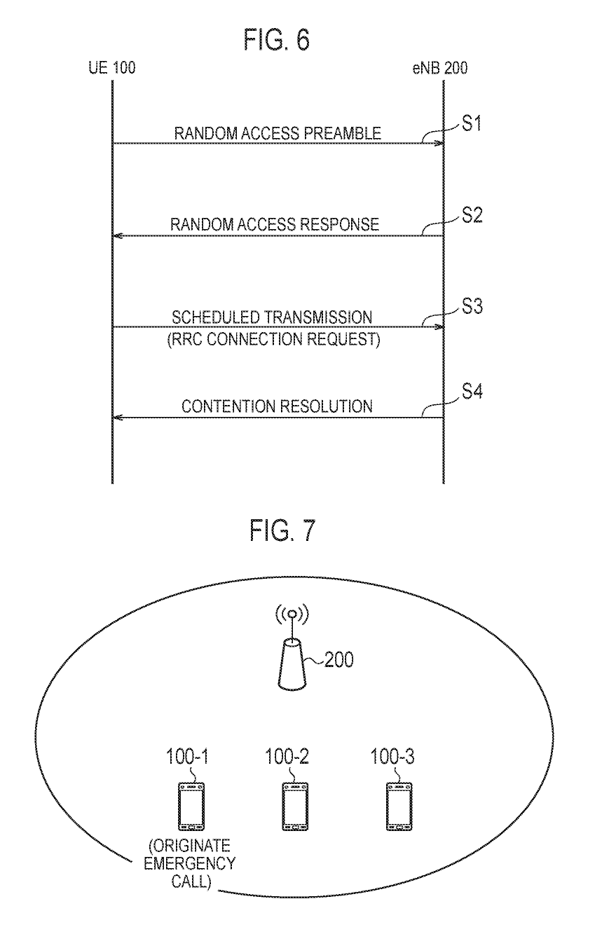

FIG. 6 is a sequence diagram showing the contention based random access procedure. The contention based random access procedure is utilized when the non-contention based random access procedure is not available, and includes the following four steps (steps S1 to S4).

As shown in FIG. 6, in step S1, the UE 100 randomly selects any preamble sequence from a preamble sequence group available for a contention based random access attempt. Information on the preamble sequence group available for the contention based random access attempt is included in system information broadcast by the eNB 200. The UE 100 transmits, by an RACH (Random Access Channel), a random access preamble by the selected preamble sequence, to the eNB 200. The random access preamble does not include an identifier (terminal identifier) of the UE 100.

In step S2, the eNB 200 that receives the random access preamble transmits a random access response to the UE 100. Here, the eNB 200 estimates an uplink delay between the eNB 200 and the UE 100, on the basis of the random access preamble received from the UE 100. Further, the eNB 200 decides a radio resource allocated to the UE 100. The random access response includes a timing correction value (TA: Timing Advance) based on a result of a delay estimation, a Temporary C-RNTI (Cell-Radio Network Temporary Identifier) that is an identifier temporarily assigned in a cell of the eNB 200, information (UL Grant) of the decided allocated radio resource, an identifier (preamble index) of a preamble sequence received from the UE 100, and the like.

In step S3, the UE 100 that receives the random access response including the preamble index corresponding to the random access preamble, transmits a connection request message (RRC Connection Request) to the eNB 200. The connection request message is a message exchanged in the RRC layer, and may be called a message 3 (Msg 3). The connection request message includes the Temporary C-RNTI and a terminal identifier. The terminal identifier is a TMSI (Temporary Mobile Subscriber Identity) unique for each UE. Further, in the connection request message, information indicating a reason why a connection is established (establish cause) may be included. The connection request message here may be replaced by Scheduled Transmission.

In step S4, the eNB 200 that receives the connection request message transmits a contention resolution message (Contention Resolution) to the UE 100. The contention resolution message is a message exchanged in the RRC layer, and may be called a message 4 (Msg 4). The contention resolution message includes the terminal identifier included in a connection request message received by the eNB 200. Specifically, the contention resolution message includes, as a contention resolution ID, the connection request message itself. The UE 100 determines, by receiving the contention resolution message including the connection request message (contention resolution ID) transmitted by the UE 100, that the random access procedure is complete.

In the above-described contention based random access procedure, a plurality of UEs 100 may transmit the random access preamble by the same preamble sequence. Such a situation is called a preamble contention (or a preamble collision).

In this case, the plurality of UEs 100 involving in the preamble contention respond to one random access response transmitted from the eNB 200, and transmits a plurality of connection request messages to the eNB 200. The eNB 200 includes a terminal identifier included in the connection request message received first, for example, into the contention resolution message. As a result, out of the plurality of UEs 100 involving in the preamble contention, a UE 100 that first transmits the connection request message establishes a connection with the eNB 200.

On the other hand, a UE 100 not designated by the contention resolution message, that is, a UE 100 not capable of correctly receiving the contention resolution message, needs to re-start, after an elapse of a predetermined time (called “backoff time”), the random access procedure from step S1. Further, the preamble contention may occur even in the second random access procedure. Therefore, the contention based random access procedure may take a longer time (that is, a longer connection process delay) required until the UE 100 establishes the connection with the eNB 200. In particular, when an emergency call (hereinafter, referred to as “VoLTE emergency call”) is originated by VoLTE, if the connection process delay is longer, this is a serious problem.

(Operation According to Embodiment)

An operation according to the embodiment will be described, below. FIG. 7 is a diagram for describing an operation environment according to the embodiment.

As shown in FIG. 7, a situation is assumed where within a coverage area of the eNB 200, a plurality of UEs (UEs 100-1 to 100-3) in an RRC idle state are located, and the plurality of UEs 100 simultaneously perform the contention based random access procedure on the eNB 200. The UE 100-1 is a UE that attempts to originate a VoLTE emergency call to a called-side terminal arranged in an organization (emergency call acceptance organization) such as a police, a fire department, and an emergency rescue. The UEs 100-2 and 100-3 are a UE that attempts to originate a call other than the VoLTE emergency call.

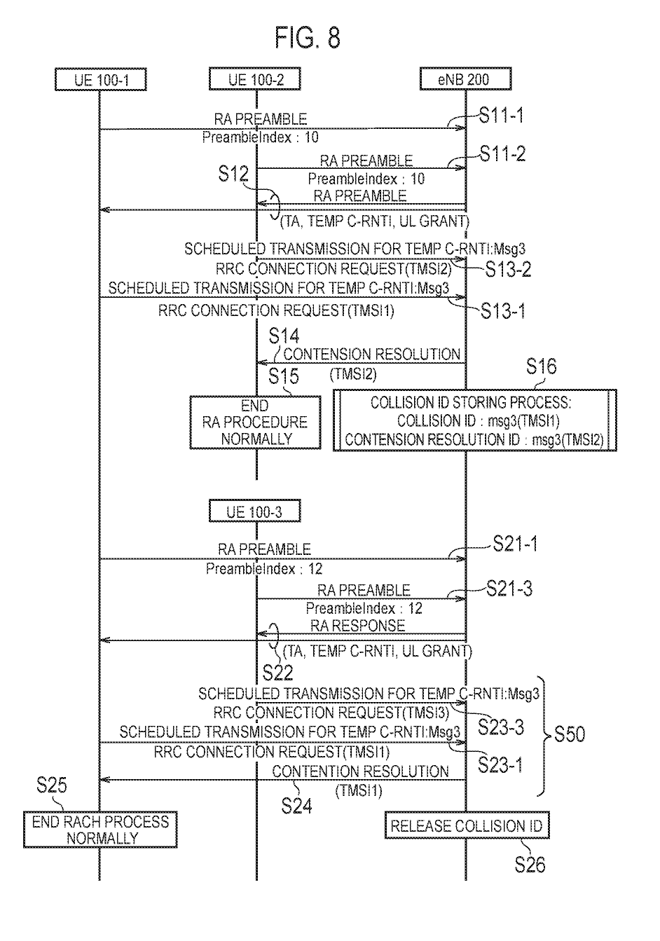

FIG. 8 is a sequence diagram showing an operation sequence according to the embodiment. FIG. 8 shows, as an example, a case where the UE 100-1 fails the first random access procedure due to the generation of the preamble contention with the UE 100-2, and thereafter, the preamble contention occurs with the UE 100-3 in the second random access procedure.

As shown in FIG. 8, in step S11-1, the UE 100-1 uses the preamble sequence corresponding to a preamble index “10” to transmit the random access preamble to the eNB 200. In step S11-2, the UE 100-2 uses the preamble sequence corresponding to the preamble index “10” to transmit the random access preamble to the eNB 200. As a result, the preamble contention occurs between the UE 100-1 and the UE 100-2.

In step S12, the eNB 200 transmits the random access response to the received random access preamble. As described above, the random access response includes a TA, a Temporary C-RNTI, UL Grant, and a preamble index. The preamble index is the preamble index “10” relating to the preamble contention.

In step S13-2, the UE 100-2 receives the random access response including the preamble index “10” corresponding to the random access preamble transmitted by the UE 100-2, and therefore, transmits a connection request message (RRC Connection Request) to the eNB 200. The connection request message includes a Temporary C-RNTI assigned from the eNB 200 and a terminal identifier (TMSI2) of the UE 100-2.

In step S13-1, the UE 100-1 receives the random access response including the preamble index “10” corresponding to the random access preamble transmitted by the UE 100-1, and therefore, transmits a connection request message (RRC Connection Request) to the eNB 200. The connection request message includes a Temporary C-RNTI assigned from the eNB 200 and a terminal identifier (TMSI1) of the UE 100-1. Further, the connection request message includes, as a reason why the connection is established (establish cause), information indicating an emergency call (emergency) (hereinafter, referred to as “emergency information”).

Further, each of the UE 100-1 and the UE 100-2 activates, when the connection request message is transmitted, a timer for defining a waiting time for receiving the contention resolution message (Contention Resolution Timer).

In step S14, the eNB 200 receives the connection request message from the UE 100-2 prior to the connection request message from the UE 100-1, and therefore, in response to the connection request message from the UE 100-2, transmits the contention resolution message to the UE 100-2. The contention resolution message includes, as the contention resolution ID, the connection request message itself from the UE 100-2.

In step S15, in response to reception of the contention resolution message destined to the UE 100-2 from the eNB 200, the UE 100-2 completes the random access procedure and establishes the RRC connection with the eNB 200.

In step S16, the connection request message from the UE 100-2 and the connection request message from the UE 100-1 include the same Temporary C-RNTI, and thus, the eNB 200 determines that the preamble contention occurs. Further, the emergency information is included in the connection request message from the UE 100-1, and thus, it is determined that the UE 100-1 not designated by the contention resolution message intends to originate the VoLTE emergency call. In this case, the eNB 200 stores the TMSI1 of the UE 100-1 as a contention ID (hereinafter, referred to as “Collision ID”). Further, the eNB 200 may store the TMSI2 of the UE 100-2 as the contention resolution ID. Step S16 will be described in detail later. It is noted that even when the emergency information is not included in the connection request message from the UE 100-1, if only the preamble contention occurs, then the eNB 200 may store the TMSI of the UE 100-1 as the contention ID. That is, the eNB 200 stores information (TMSI, for example) on the UE 100 that fails to establish the connection with the eNB 200 due to the preamble contention, into the memory 230 (storage unit). Further, the eNB 200 preferably stores information (TMSI, for example) on the UE 100 that fails to establish the connection with the eNB 200 due to the preamble contention and transmits the connection request message including emergency call information, into the memory 230 (storage unit).

When storing the Collision ID, the eNB 200 performs the connection guarantee (step S50) for preferentially connecting the UE 100-1 corresponding to the Collision ID, in the subsequent random access procedure.

In step S21-1, the timer (ContentionResolutionTimer) expires without the contention resolution message destined to the UE 100-1 not being received from the eNB 200, and thus, the UE 100-1 determines that the first random access procedure is failed, and starts the second random access procedure. Here, the UE 100-1 uses the preamble sequence corresponding to a preamble index “12” to transmit the random access preamble to the eNB 200.

In step S21-3, the UE 100-3 uses the preamble sequence corresponding to the preamble index “12” to transmit the random access preamble to the eNB 200. As a result, the preamble contention occurs between the UE 100-1 and the UE 100-3.

In step S22, the eNB 200 transmits the random access response to the received random access preamble. As described above, the random access response includes a TA, a Temporary C-RNTI, UL Grant, and a preamble index. The preamble index is the preamble index “12” relating to the preamble contention.

In step S23-3, the UE 100-3 receives the random access response including the preamble index “12” corresponding to the random access preamble transmitted by the UE 100-2, and therefore, transmits a connection request message (RRC Connection Request) to the eNB 200. The connection request message includes a Temporary C-RNTI assigned from the eNB 200 and a terminal identifier (TMSI3) of the UE 100-3.

In step S23-1, the UE 100-1 receives the random access response including the preamble index “12” corresponding to the random access preamble transmitted by the UE 100-1, and therefore, transmits a connection request message (RRC Connection Request) to the eNB 200. The connection request message includes a Temporary C-RNTI assigned from the eNB 200 and a terminal identifier (TMSI1) of the UE 100-1.

In step S24, even when receiving the connection request message sent from the UE 100-3 prior to the connection request message sent from the UE 100-1, without transmitting the contention resolution message in response to the connection request message sent from the UE 100-3, to the UE 100-3, the eNB 200 that stores the TMSI1 of the UE 100-1, as the Collision ID, transmits the contention resolution message to the UE 100-1 in response to the connection request message sent from the UE 100-1. That is, the contention resolution message includes, as the contention resolution ID, the connection request message itself from the UE 100-1. The connection guarantee (step S50) according to step S23 and step S24 will be described in detail later.

In step S25, in response to reception of the contention resolution message destined to the UE 100-1 from the eNB 200, the UE 100-1 completes the random access procedure and establishes the RRC connection with the eNB 200.

In step S26, the eNB 200 releases the Collision ID (TMSI1). Specifically, the eNB 200 erases the stored Collision ID (TMSI1).

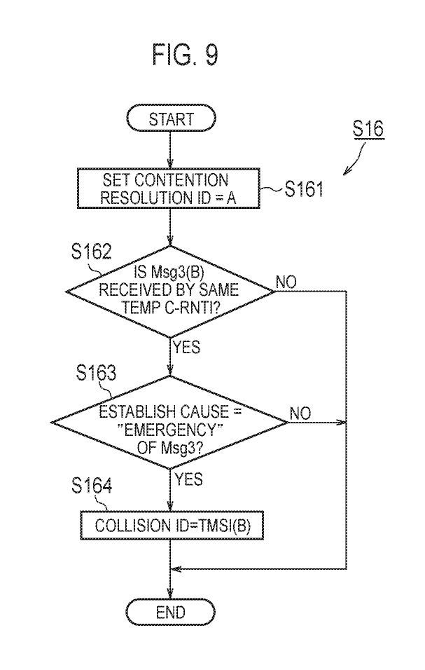

FIG. 9 is a flowchart showing a detail of a Collision ID storing process according to step S16 of FIG. 8.

As shown in FIG. 9, in step S161, the eNB 200 that receives the connection request message transmits the contention resolution message in response to the connection request message, and stores, as the contention resolution ID, the TMSI (A) of the UE 100 designated by the contention resolution message.

In step S162, the eNB 200 determines whether or not to receive another connection request message including the same Temporary C-RNTI as the previously received connection request message.

When receiving the other connection request message including the same Temporary C-RNTI as the previously received connection request message (step S162; YES), in step S163, the eNB 200 determines whether or not the emergency information is included in the other connection request message.

When the emergency information is included in the other connection request message (step S163; YES), in step S164, the eNB 200 stores, as the Collision ID, the TMSI (B) included in the other connection request message.

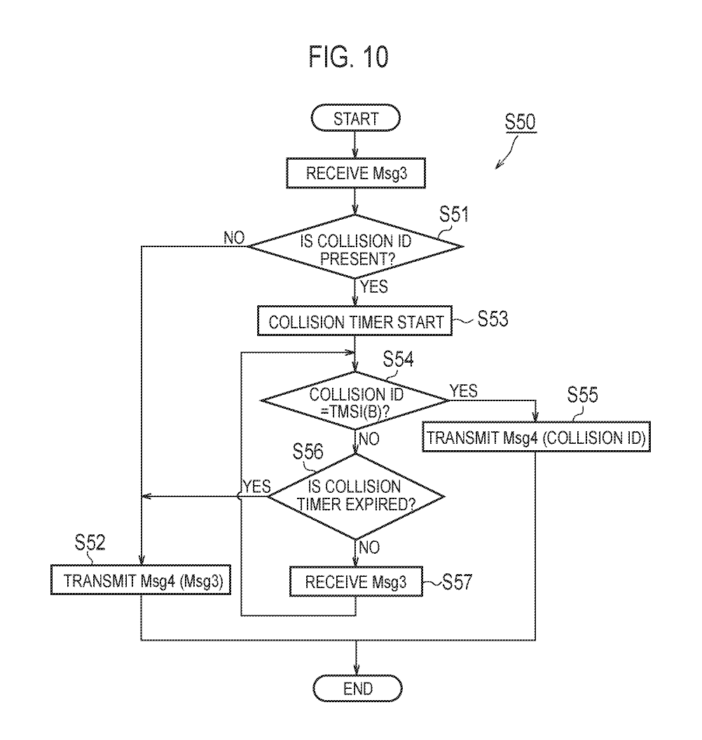

FIG. 10 is a flowchart showing a detail of the connection guarantee according to step S50 of FIG. 8.

As shown in FIG. 10, in step S51, the eNB 200 that receives the connection request message determines whether or not the Collision ID is stored. When the Collision ID is not stored (step S51; NO), the eNB 200 transmits the contention resolution message in response to the received connection request message.

On the other hand, when the Collision ID is stored (step S51; YES), in step S53, the eNB 200 activates a timer (Collision Timer) for defining a waiting time for receiving the connection request message in which the TMSI included in the connection request message matches the Collision ID.

In step S54, the eNB 200 determines whether or not the TMSI included in the received connection request message matches the Collision ID. When the TMSI included in the received connection request message matches the Collision ID (step S54; YES), in step S55, the eNB 200 transmits the contention resolution message that responds to the received connection request message.

On the other hand, when the TMSI included in the received connection request message does not match the Collision ID (step S54; NO), in step S56, the eNB 200 determines whether or not the timer (Collision Timer) expires. When the timer (Collision Timer) expires (step S56; YES), in step S52, the eNB 200 transmits the contention resolution message that responds to the received connection request message (that is, the connection request message in which the TMSI included in the connection request message does not match the Collision ID).

When the timer (Collision Timer) does not expire (step S56; NO), in step S57, the eNB 200 receives the connection request message by waiting for the connection request message. Thereafter, the eNB 200 returns the process to step S54.

(Summary of Embodiment)

As described above, when receiving a plurality of connection request messages corresponding to the same random access response from the plurality of UEs 100, the eNB 200 selects the connection request message that satisfies a predetermined condition (that the TMSI included in the connection request message matches the Collision ID) from among the plurality of connection request messages, and transmits the contention resolution message in response to the selected connection request message.

Thus, when the appropriate connection request message is selected from among the plurality of connection request messages corresponding to the same random access response, it is possible to improve the contention based random access procedure.

In the embodiment, until a predetermined time (that is, a time defined by the Collision Timer) passes since the random access response is transmitted, the eNB 200 performs, even when receiving the connection request message that does not satisfy the predetermined condition, a waiting process of waiting for the connection request message that satisfies the predetermined condition without transmitting the contention resolution message in response the connection request message.

Thus, rather than transmitting the contention resolution message in response the previously received connection request message, the connection request message that satisfies the predetermined condition is waited until the predetermined time passes. As a result, even when the connection request message that satisfies the predetermined condition is received subsequently, it is possible to transmit the contention resolution message in response to the subsequently received connection request message.

In the embodiment, when receiving the connection request message that does not satisfy the predetermined condition until a predetermined time passes since the random access response is transmitted, the eNB 200 transmits, without transmitting the contention resolution message in response to the connection request message until the predetermined time passes, the contention resolution message in response to the connection request message after the predetermined time passes.

Thus, if it is not possible to receive the connection request message that satisfies the predetermined condition within the predetermined time, then when the contention resolution message is transmitted even when the connection request message that does not satisfy the predetermined condition is received, the UE 100 that transmits the connection request message that does not satisfy the predetermined condition is capable of establishing the RRC connection.

In the embodiment, the eNB 200 performs the waiting process when in the previous contention based random access procedure, there is an unconnected UE (hereinafter, referred to as “unconnected UE relating to the preamble contention”) not capable of having established the connection with the eNB 200 due to the preamble contention. Specifically, the eNB 200 stores, as the Collision ID, the terminal identifier of the unconnected UE relating to the preamble contention. The connection request message that satisfies the predetermined condition is a connection request message including the stored Collision ID.

Thus, when the eNB 200 that stores the terminal identifier of the unconnected UE relating to the preamble contention waits, in the random access procedure, for the connection request message from the unconnected UE, the unconnected UE is capable of being preferentially connected.

In the embodiment, the eNB 200 performs the waiting process when there is the unconnected UE relating to the preamble contention and in the previous contention based random access procedure, the emergency information is included in the connection request message received from the unconnected UE.

Thus, when the eNB 200 stores, as a Collision ID, a terminal identifier of a UE intending to originate a VoLTE emergency call, out of the unconnected UEs relating to the preamble contention and waits, in the random access procedure, for the connection request message sent from the UE, the UE is capable of preferentially being connected.

[First Modification]

In the above-described embodiment, the eNB 200 stores, as the Collision ID, the terminal identifier of the UE that intends to originate the VoLTE emergency call, out of the unconnected UEs relating to the preamble contention. That is, in the above-described embodiment, a case is shown, as an example, where only the UE that intends to originate the VoLTE emergency call, out of the unconnected UEs relating to the preamble contention, is subject to the connection guarantee.

However, the eNB 200 may store, as the Collision ID, the terminal identifier of the unconnected UE, irrespective of whether the unconnected UE relating to the preamble contention intends to originate the VoLTE emergency call. According to a first modification of the embodiment, it is possible to consider, as an UE subject to the connection guarantee, not only the UE that intends to originate the VoLTE emergency call but also all the unconnected UEs relating to the preamble contention.

In the first modification of the embodiment, step S163 in FIG. 9 is omitted. Specifically, in FIG. 9, when receiving another connection request message including the same Temporary C-RNTI as the previously received connection request message (step S162; YES), in step S164, the eNB 200 stores, as the Collision ID, the TMSI (B) included in the other connection request message without determining whether or not the emergency information is included in the other connection request message.

[Second Modification]

In the above-described embodiment, as long as storing the Collision ID, the eNB 200 performs the waiting process of waiting for the connection request message that satisfies the Collision ID. That is, in the above-described embodiment, a case is shown, as an example, where as long as there is the unconnected UE relating to the preamble contention, the eNB 200 performs the waiting process.

However, the eNB 200 may perform, irrespective of whether storing the Collision ID, the waiting process of waiting for the connection request message including the emergency information. Thus, in a second modification of the embodiment, the connection request message that satisfies the predetermined condition is a connection request message including the emergency information. According to the second modification of the embodiment, it is possible to consider all the time, as the UE subject to the connection guarantee, the UE that intends to originate the VoLTE emergency call.

In the second modification of the embodiment, steps S11 to S16 in FIG. 8 are omitted. Further, step S51 in FIG. 10 is omitted. Further, in step S54 in FIG. 10, instead of determining whether or not the TMSI included in the received connection request message matches the Collision ID, the eNB 200 determines whether or not the emergency information is included in the received connection request message. Then, when the emergency information is included in the received connection request message (step S54; YES), in step S55, the contention resolution message is transmitted in response to the received connection request message. On the other hand, when the emergency information is not included in the received connection request message (step S54; NO), in step S57, the connection request message is waited and the connection request message is thereby received. Thereafter, the eNB 200 returns the process to step S54.

### Other Embodiments

In the above-described embodiment, the LTE system is used as an example; however, the embodiment is not limited to the application to the LTE system and may be applied to a system other than the LTE system.

Characteristics of the above-described embodiment may be expressed as follows.

A first characteristic lies in a base station that transmits, in a contention based random access procedure, a random access response in response to reception of a random access preamble, including: a controller configured to select a connection request message that satisfies a predetermined condition from among a plurality of connection request messages, when receiving the plurality of connection request messages corresponding to the random access response from a plurality of user terminals, and transmit a contention resolution message in response to the selected connection request message.

In the first characteristic, until a predetermined time passes since the random access response is transmitted, even when receiving a connection request message that does not satisfy the predetermined condition, the controller performs a waiting process of waiting for the connection request message that satisfies the predetermined condition, without transmitting the contention resolution message in response to the connection request message.

In the first characteristic, when receiving the connection request message that does not satisfy the predetermined condition until a predetermined time passes since the random access response is transmitted, the controller transmits the contention resolution message in response to the connection request message after the predetermined time passes, without transmitting the contention resolution message in response to the connection request message until the predetermined time passes.

In the first characteristic, when there is an unconnected terminal not capable of having established a connection with the base station due to a preamble contention in a previous contention based random access procedure, the controller performs the waiting process.

In the first characteristic, when there is the unconnected terminal and emergency call information is included in a connection request message received from the unconnected terminal in a previous contention based random access procedure, the controller performs the waiting process.

In the first characteristic, the connection request message that satisfies the predetermined condition is a connection request message including a terminal identifier of the unconnected terminal.

In the first characteristic, the connection request message that satisfies the predetermined condition is a connection request message including emergency call information.

A second characteristic lies in a method in a base station that transmits, in a contention based random access procedure, a random access response in response to reception of a random access preamble, the method comprising the steps of: selecting, when receiving a plurality of connection request messages corresponding to the random access response from a plurality of user terminals, a connection request message that satisfies a predetermined condition from among the plurality of connection request messages; and transmitting the contention resolution message in response to the selected connection request message.

It is noted that the entire content of Japanese Patent Application No. 2013-266175 (filed on Dec. 24, 2013) is incorporated in the present specification by reference.

### INDUSTRIAL APPLICABILITY

According to the embodiment, it is possible to improve a contention based random access procedure.

1. A base station that, when receiving a random access preamble transmitted from a plurality of user terminals in a contention based random access procedure, transmits a random access response to the plurality of user terminals, comprising:
a controller configured to select, when receiving a plurality of connection request messages transmitted by the plurality of user terminals in response to the random access response, a connection request message that satisfies a predetermined condition from among the plurality of connection request messages and to transmit a contention resolution message corresponding to the selected connection request message.

2. The base station according to claim 1, wherein
when receiving a connection request message that does not satisfy the predetermined condition until a predetermined time passes since the random access response is transmitted, the controller withholds transmission of the contention resolution message corresponding to the connection request message until the predetermined time passes.

3. The base station according to claim 2, wherein
when receiving, until the predetermined time passes, the connection request message that satisfies the predetermined condition after receiving the connection request message that does not satisfy the predetermined condition, the controller transmits the contention resolution message corresponding to the connection request message that satisfies the predetermined condition.

4. The base station according to claim 1, wherein
when receiving the connection request message that does not satisfy the predetermined condition until a predetermined time passes since the random access response is transmitted, the controller transmits the contention resolution message corresponding to the connection request message after the predetermined time passes, without transmitting the contention resolution message corresponding to the connection request message until the predetermined time passes.

5. The base station according to claim 1, further comprising
a memory configured to store information on a user terminal that fails to establish a connection with the base station due to a preamble contention in a previous contention based random access procedure, wherein
the controller determines that a connection request message transmitted from the user terminal stored in the memory is a connection request message that satisfies the predetermined condition.

6. The base station according to claim 5, wherein
the memory stores information on a user terminal that fails to establish a connection with the base station due to a preamble contention in a previous contention based random access procedure and that transmits a connection request message including emergency call information.

7. A processor installed in a base station that transmits, when receiving a random access preamble transmitted from a plurality of user terminals in a contention based random access procedure, a random access response to the plurality of user terminals, wherein
the processor selects, when receiving a plurality of connection request messages transmitted by the plurality of user terminals in response to the random access response, a connection request message that satisfies a predetermined condition from among the plurality of connection request messages and transmits a contention resolution message corresponding to the selected connection request message.

8. A method in a base station that, when receiving a random access preamble transmitted from a plurality of user terminals in a contention based random access procedure, transmits a random access response to the plurality of user terminals, comprising the steps of:
selecting, when receiving a plurality of connection request messages transmitted by the plurality of user terminals in response to the random access response, a connection request message that satisfies a predetermined condition from among the plurality of connection request messages; and
transmitting a contention resolution message corresponding to the selected connection request message.
